(19) United States
(12) Patent Application Publication
(10) Pub. No.: US 2014/0195516 A1
(43) Pub. Date: Jul. 10, 2014

(54) SYSTEMS AND METHODS FOR PRESENTING CONTENT ITEMS IN A COLLECTIONS VIEW

(71) Applicant: Dropbox, Inc., San Francisco, CA (US)

(72) Inventors: Ramesh Balakrishnan, San Francisco, CA (US); Josiah Boning, Sunnyvale, CA (US)

(73) Assignee: Dropbox, Inc., San Francisco, CA (US)

(21) Appl. No.: 14/054,103

(22) Filed: Oct. 15, 2013

Related U.S. Application Data
(60) Provisional application No. 61/750,791, filed on Jan. 9, 2013.

(51) Int. Cl. G06F 17/30

(52) U.S. Cl. CPC G06F 17/30876; G06F 17/30554
USPC 707/722

(57) ABSTRACT

Systems, methods, and computer-readable media are provided for managing, creating, and presenting a virtual collection. In some embodiments, a content management system can receive a request to display a virtual collection of content items from a first user account, whereupon at least one content identifier stored for the virtual collection can be retrieved. The at least one content identifier can identify at least one content item in data storage. Subsequently, updated information can retrieved for the at least one content item, including at least one of an updated location within a file system hierarchy or a modification to the at least one content item by a second user account, for example. An updated content item can then be selectively provided for display with the virtual collection in accordance with accessibility to the content item permitted by the second user account.

### CROSS-REFERENCE TO RELATED PROVISIONAL APPLICATION

This application claims the benefit of U.S. Provisional Patent Application No. 61/750,791, filed Jan. 9, 2013, the disclosure of which is incorporated herein by reference in its entirety.

### BACKGROUND

Traditional file system user interfaces have a hierarchical structure with all files and directories appearing under a root “/” directory. Files stored in the file system may be grouped together by storing each file within a directory or a folder. While the traditional file system user interface has many advantages, it is not always conducive to selecting files for inclusion in a group, such as a photo album. To group files in a directory using a traditional file system user interface, a user must first create a directory within the hierarchical structure and then browse the hierarchy to locate file for inclusion in the group. To find each file for the group, the user must then navigate through the hierarchy, select to display the contents of a directory in the hierarchy, and then select a file within the selected directory to be copied and stored within the created directory. This process must be repeated for every file to be stored within the created directory.

This traditional method for organizing files is time consuming for the user because it requires the user must remember where to find each file and navigate to the desired version of the file. It may be particularly difficult for the user to locate files that were provided by someone else because the files might not be stored within the same hierarchical structure as the user's own files. For example, files provided by someone else may be stored in a mailbox or a separate download directory, for example. Furthermore, requiring a user to copy and store each file into each new directory can result in inefficient use of storage resources, particularly when the same files may need to be grouped, regrouped, updated, and shared repeatedly, as may be the case with photo albums.

Thus, there is a need for a user interface that is more conducive to creating groups of files and provides a more efficient use of storage resources than the traditional methods discussed above.

### SUMMARY

Embodiments are provided for managing, creating, and presenting a virtual collection of content items stored, managed, and/or synchronized by a content management system. A virtual collection can preserve data related to collections of content items, such as photo albums, via collection tags so that collections persist even after files are moved or otherwise manipulated via various file interfaces. Each content item in a virtual collection can be associated with a tag that can be preserved through the life of the item, even if the content item is copied, moved, and/or modified. The tag can include one or more collection identifiers to identify which collection(s) the content item is associated with. When a content item associated with a virtual collection is renamed, moved, and/or modified, an index of items associated with the collection identified by the tag can be automatically updated to note the correct location and/or address of the content item.

Each content item stored, managed, and/or synchronized by the content management system can also be associated with a content identifier. A virtual collection can reference such content identifiers to retrieve content items that are associated with the virtual collection even if the content items are physically stored in diverse locations, such as in different folders in a file system hierarchy or in wholly separate file systems, for example, can be seamlessly retrieved and displayed as part of a virtual collection. Because content items can be retrieved from separate file systems managed by the content management system, content items stored in storage space allocated for one user account may also be accessed, edited, shared, or otherwise managed by another user account with sufficient access permissions, such as access to the content item via a virtual collection. The virtual collection can reflect any changes made to such content items, including changes made locally on a client device associated with a particular user account, such that the most up to date information regarding the content items is available to all user accounts with access to the virtual collection.

Further, virtual collections can be presented to a user within a collections-based user interface rather than in a hierarchical folder structure regardless of whether the displayed content items are physically stored in separate file system folders or primarily associated with another user account of the content management system. Such a collections-based user interface may be especially beneficial for creating, editing, and managing files for inclusion in other virtual collections as well as for certain hardware platforms, such as mobile devices or televisions, on which navigating through a file system hierarchy may be particularly difficult.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 shows an exemplary system for presenting content items using a collections view, in accordance with some embodiments;

FIG. 2 shows a schematic representation for storage of data for presenting content items using a collections view, in accordance with some embodiments;

FIG. 3 shows a flowchart of a process for presenting content items using a collections view, in accordance with some embodiments;

FIG. 4 shows a flowchart of another process for presenting content items using a collections view, in accordance with some embodiments; and

FIGS. 5-14 show various illustrative user interfaces for presenting content items using a collections view, in accordance with various embodiments.

### DETAILED DESCRIPTION OF THE DISCLOSURE

Methods, systems, and computer-readable media for the creation, retrieval, storage, and presentation of a virtual collection of content items are provided. A virtual collection for an account registered with a content management system can reference one or more content identifiers associated with content items managed, stored, and/or synchronized by the final storage management system. The virtual collection may be created by selecting existing content items stored and/or managed by the content management system and associating the selected content items with the virtual collection (e.g., by associating storage locations, content identifiers, and/or addresses of stored content items with the virtual collection). By associating existing content items with the virtual collection, a content item can be designated as part of the virtual collection without having to physically store the content item in another location (e.g., by copying and pasting the content item file to a directory) within data storage in order to place the content item in the collection.

A content item may be any item that includes content accessible to a user of a mobile device. The use of “content item” or “content items” is used herein to refer broadly to various file types. In some embodiments, content items may include digital photographs, documents, music, videos, or any other type of file, or any combination thereof and should not be read to be limited to one specific type of content item. In some embodiments the content items may be stored in memory of a mobile device, on a content management system, on a social media network, or any other location, or any combination thereof.

Content items may be designated as part of a virtual collection by associating the virtual collection with the content item. The virtual collection may be associated with content identifiers including, but not limited to, a content identifier string associated with the content item stored in a database table, a pointer to an address for the content item in a storage, a reference to the content item, a content identifier associated with the file, and/or any other suitable identifier that identifies the content item stored within data storage managed by the file storage management service. In some embodiments, the content identifier may be stored in a database table with a virtual collection identifier, and the content identifier may identify an address in data storage that can be accessed for retrieval of one or more content items (e.g., files or portions of files representing images, videos, documents, songs, etc.) within the virtual collection.

The content management system may offer a file hosting service, a cloud storage service, a file storage management service, a content management service, and/or any other network hosting service that allows for upload, access, retrieval, and management of content so that it is accessible over a network (e.g., the internet) by electronic devices using an authenticated account. An amount of storage space within data storage of the content management system may be authorized for use by each account. In some embodiments, files stored locally at a client device may be uploaded to the content management system and may be accessed with an authenticated account. Any content items that are accessible to an account of the content management system may be designated as part of a virtual collection for the account. Accessible content items for an account may be content items stored for the authenticated account within data storage of the content management system and/or content items shared with the authenticated account from another account.

A first user account may have access to content items shared with the first user account from other accounts. These shared content items may be added to virtual collections that can be created, accessed, and/or retrieved by the first user account. In some embodiments, a virtual collection for a first user account may include a content item in storage associated with a second user account of the content management system. For example, the virtual collection identifier for a virtual collection associated with a first user account may be associated with a content identifier for a content item stored within data storage authorized for use by a second user account. In some embodiments, the content item stored in the storage designated for the second user account may be shared with the first user account to allow for inclusion in a virtual collection associated with the first user account. When the virtual collection for the first user account is requested, the storage location for the content item authorized for use by the second user account may be accessed to present the content item within the virtual collection of the first user account.

The content management system can provide a user with access to remote file storage and management capabilities. The user may interact with the content management system using a user interface of a stand-alone application on a client device and/or an application implemented with an application-programming interface (API) provided by the content management system. The user interface may allow the user to interact with content management system and utilize the functionality of the file storage management system for retrieval and/or access to content items. For example, the user interface may allow the user to create, store retrieve, share, and/or manage virtual collections associated with the user's account.

In some embodiments, a virtual collection may be built on top of a file system abstraction. A file system abstraction may be an abstraction layer that hides the implementation details for storage, access, and/or retrieval of content within physical storage. For example, the file system abstraction can hide the implementation details for actual physical storage of content within data storage of a file storage provider and/or locally stored on an electronic device. In some embodiments, the content management system may not store files in the same hierarchical structure that the files are stored within the file system on the client device. However, metadata associated with the content uploaded to the content management system from a client device with information on the hierarchical structure for storage of the content on the client device, and the user interface for content management system may replicate the hierarchical structure on the client device in a user interface to present a traditional view of the file system. In other embodiments, the user interface may provide a view of a flattened hierarchical structure of the file system and/or a subset of content stored for the user account.

For purposes of description and simplicity, methods, systems and computer readable media will be described for presenting content items in a collections view. However, the terms “device” and “content management system” are used herein to refer broadly to a wide variety of storage providers and management service providers, electronic devices and mobile devices, as well as to a wide variety of types of content, files, portions of files, and/or other types of data. The term “user” is also used herein broadly and may correspond to a single user, multiple users, authorized accounts, or any other user type, or any combination thereof. Those with skill in the art will recognize that the methods, systems, and media described may be used for a variety of storage providers/services and types of content, files, portions of files, and/or other types of data.

The present invention may take form in various components and arrangements of components, and in various techniques, methods, or procedures and arrangements of steps. The referenced drawings are only for the purpose of illustrating embodiments, and are not to be construed as limiting the present invention. Various inventive features are described below that may each be used independently of one another or in combination with other features.

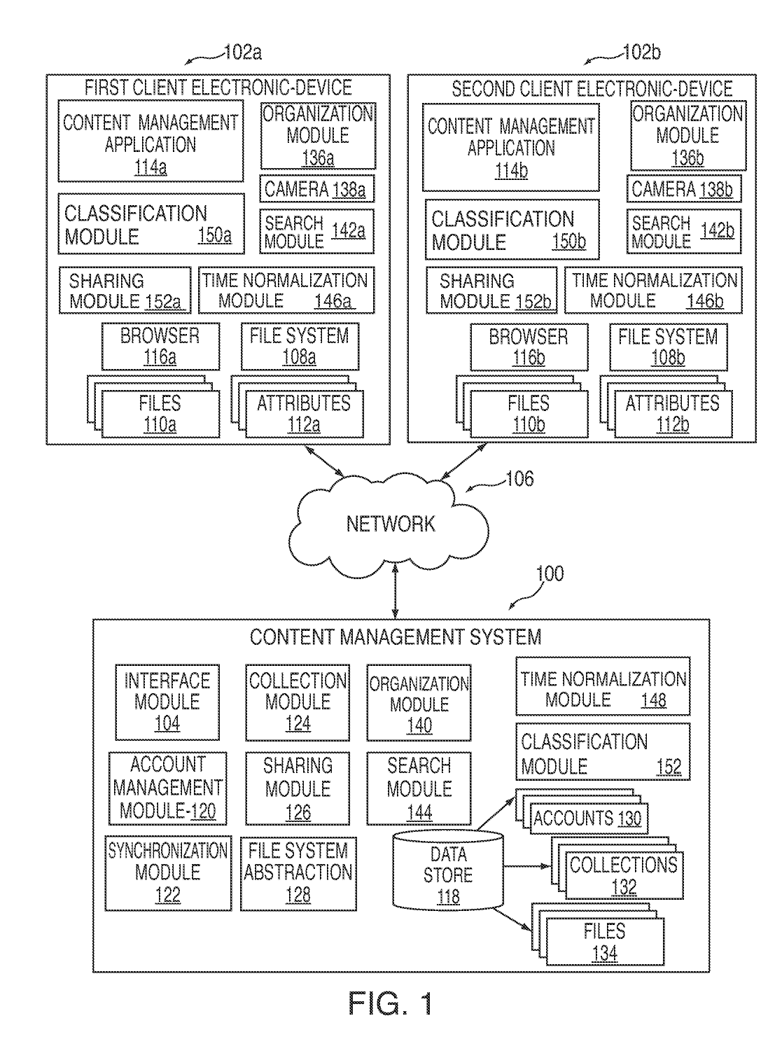

FIG. 1 is an exemplary system for presenting content items using a collections view in accordance with some embodiments. Elements in FIG. 1, including, but not limited to, first client electronic device 102a, second client electronic device 102b, and content management system 100, may communicate with each other and/or additional components inside or outside the system by sending and/or receiving data over network 106. Network 106 may be any network, combination of networks, or network devices that may carry data communication. For example, network 106 may be any one or any combination of a LAN (local area network), WAN (wide area network), telephone network, wireless network, point-to point network, star network, token ring network, hub network, or any other suitable network.

Network 106 may support any number of protocols, including but not limited to TCP/IP (Transfer Control Protocol and Internet Protocol), HTTP (Hypertext Transfer Protocol), WAP (wireless application protocol), etc. For example, first client electronic device 102a and second client electronic device 102b (collectively 102) may communicate with content management system 100 using TCP/IP, and, at a higher level, use browser 116 to communicate with a web server (not shown) at content management system 100 using HTTP. Exemplary implementations of browser 116, include, but are not limited to, Google Inc. Chrome™ browser, Microsoft Internet Explorer®, Apple Safari®, Mozilla Firefox, and Opera Software Opera.

A variety of client electronic devices 102 may communicate with content management system 100, including, but not limited to, desktop computers, mobile computers, mobile communication devices (e.g., mobile phones, smart phones, tablets), televisions, set-top boxes, and/or any other network enabled device. Although two client electronic devices 102a and 102b are illustrated for description purposes, those with skill in the art will recognize that any number of devices may be supported by and/or communicate with content management system 100. Client electronic devices 102 may be used to create, access, modify, and manage files 110a and 110b (collectively 110) (e.g. files, file segments, images, etc.) stored locally within file system 108a and 108b (collectively 108) on client electronic device 102 and/or stored remotely with content management system 100 (e.g., within data store 118). For example, client electronic device 102a may access file 110b stored remotely with data store 118 of content management system 100 and may or may not store file 110b locally within file system 108a on client electronic device 102a. Continuing with the example, client electronic device 102a may temporarily store file 110b within a cache (not shown) locally within client electronic device 102a, make revisions to file 110b, and communicate and store the revisions to file 110b in data store 118 of content management system 100. Optionally, a local copy of the file 110a may be stored on client electronic device 102a.

Client devices 102 may capture, record, and/or store content items, such as image files 110. For this purpose, client devices 102 may include a camera 138 (e.g., 138a and 138b) to capture and record digital images and/or videos. For example, camera 138 may capture and record images and store metadata with the images. Metadata may include, but is not limited to, the following: creation time timestamp, geolocation, orientation, rotation, title, and/or any other attributes or data relevant to the captured image.

Metadata values may be stored in attribute 112 as name-value pairs, tag-value pairs, and/or using any other suitable method to associate the metadata with the file and easily identify the type of metadata. In some embodiments, attributes 112 may be tag-value pairs defined by a particular standard, including, but not limited to, Exchangeable Image File Format (Exif), JPEG File Interchange Format (Jfif), and/or any other standard.

A time normalization module 146 (e.g., 146a and 146b) may be used to normalize dates and times stored with a content item. An example of time normalization is provided in U.S. patent application Ser. No. 13/888,118, entitled “Date and Time Handling,” filed on May 6, 2013, which is incorporated herein by reference in its entirety. Time normalization module 146, counterpart time normalization module 148, and/or any combination thereof may be used to normalize dates and times stored for content items. The normalized times and dates may be used to sort, group, perform comparisons, perform basic math, and/or cluster content items.

Organization module 136 (e.g., 136a and 136b) may be used to organize content items (e.g., image files) into clusters, organize content items to provide samplings of content items for display within user interfaces, and/or retrieve organized content items for presentation. Various examples of organizing content items are more fully described in commonly owned U.S. patent application Ser. No. 13/888,186, entitled “Presentation and Organization of Content,” filed on May 6, 2013, which is incorporated herein by reference in its entirety.

The organization module 136 may utilize any suitable clustering algorithm. The organization module 136 may be used to identify similar images for clusters in order to organize content items for presentation within user interfaces on devices 102 and content management system 100. Similarity rules may be defined to create one or more numeric representations embodying information on similarities between each of the content items in accordance with the similarity rules. The organization module 136 may use the numeric representation as a reference for similarity between content items in order to cluster the content items.

In some embodiments, content items may be organized into clusters to aid with retrieval of similar content items in response to search requests. For example, organization module 136a may identify that two stored images are similar and may group the images together in a cluster. Organization module 136a may process image files to determine clusters independently or in conjunction with counterpart organization module (e.g., 140 and/or 136b). In other embodiments, organization module 136a may only provide clusters identified with counterpart organization modules (e.g., 140 and/or 136b) for presentation. Continuing with the example, processing of image files to determine clusters may be an iterative process that is executed upon receipt of new content items and/or new similarity rules.

In some embodiments, a search module 142 on client device 102 may be provided with a counterpart search module 144 on content management system 144 to support search requests for content items. A search request may be received by search module 142 and/or 144 that requests a content item. In some embodiments, the search may be handled by searching metadata and/or attributes assigned to content items during the provision of management services. For example, cluster markers stored with images may be used to find images by date. In particular, cluster markers may indicate an approximate time or average time for the images stored with the cluster marker in some embodiments, and the marker may be used to speed the search and/or return the search results with the contents of the cluster with particular cluster markers.

Files 110 managed by content management system 100 may be stored locally within file system 108 of respective devices 102 and/or stored remotely within data store 118 of content management system 100 (e.g., files 134 in data store 118). Content management system 100 may provide synchronization of files managed by content management system 100. Attributes 112a and 112b (collectively 112) or other metadata may be stored with files 110. For example, a particular attribute may be stored with the file to track files locally stored on client devices 102 that are managed and/or synchronized by content management system 100. In some embodiments, attributes 112 may be implemented using extended attributes, resource forks, or any other implementation that allows for storing metadata with a file that is not interpreted by a file system. In particular, an attribute 112a and 112b may be a content identifier for a file. For example, the content identifier may be a unique or nearly unique identifier (e.g., number or string) that identifies the file.

By storing a content identifier with the file, a file may be tracked. For example, if a user moves the file to another location within the file system 108 hierarchy and/or modifies the file, then the file may still be identified within the local file system 108 of a client device 102. Any changes or modifications to the file identified with the content identifier may be uploaded or provided for synchronization and/or version control services provided by the content management system 100.

A stand-alone content management application 114a and 114b (collectively 114), client application, and/or third-party application may be implemented to provide a user interface for a user to interact with content management system 100. Content management application 114 may expose the functionality provided with content management interface 104 and accessible modules for device 102. Web browser 116a and 116b (collectively 116) may be used to display a web page front end for a client application that may provide content management 100 functionality exposed/provided with content management interface 104.

Content management system 100 may allow a user with an authenticated account to store content, as well as perform management tasks, such as retrieve, modify, browse, synchronize, and/or share content with other accounts. Various embodiments of content management system 100 may have elements, including, but not limited to, content management interface module 104, account management module 120, synchronization module 122, collections module 124, sharing module 126, file system abstraction 128, data store 118, and organization module 140. The content management service interface module 104 may expose the server-side or back end functionality/capabilities of content management system 100. For example, a counter-part user interface (e.g., stand-alone application, client application, etc.) on client electronic devices 102 may be implemented using content management service interface 104 to allow a user to perform functions offered by modules of content management system 100. In particular, content management system 100 may have an organization module 140 for identifying similar content items for clusters and samples of content items for presentation within user interfaces.

The user interface offered on client electronic device 102 may be used to create an account for a user and authenticate a user to use an account using account management module 120. The account management module 120 of the content management service may provide the functionality for authenticating use of an account by a user and/or a client electronic device 102 with username/password, device identifiers, and/or any other authentication method. Account information 130 may be maintained in data store 118 for accounts. Account information may include, but is not limited to, personal information (e.g., an email address or username), account management information (e.g., account type, such as “free” or “paid”), usage information, (e.g., file edit history), maximum storage space authorized, storage space used, content storage locations, security settings, personal configuration settings, content sharing data, etc. An amount of content management may be reserved, allotted, allocated, stored, and/or may be accessed with an authenticated account. The account may be used to access files 110 within data store 118 for the account and/or files 110 made accessible to the account that are shared from another account. Account module 120 may interact with any number of other modules of content management system 100.

An account may be used to store content, such as documents, text files, audio files, video files, etc., from one or more client devices 102 authorized on the account. The content may also include folders of various types with different behaviors, or other mechanisms of grouping content items together. For example, an account may include a public folder that is accessible to any user. The public folder may be assigned a web-accessible address. A link to the web-accessible address may be used to access the contents of the public folder. In another example, an account may include a photos folder that is intended for photos and that provides specific attributes and actions tailored for photos; an audio folder that provides the ability to play back audio files and perform other audio related actions; or other special purpose folders. An account may also include shared folders or group folders that are linked with and available to multiple user accounts. The permissions for multiple users may be different for a shared folder.

Content items (e.g., files 110) may be stored in data store 118. Data store 118 may be a storage device, multiple storage devices, or a server. Alternatively, data store 118 may be cloud storage provider or network storage accessible via one or more communications networks. Content management system 100 may hide the complexity and details from client devices 102 by using a file system abstraction 128 (e.g., a file system database abstraction layer) so that client devices 102 do not need to know exactly where the content items are being stored by the content management system 100. Embodiments may store the content items in the same folder hierarchy as they appear on client device 102. Alternatively, content management system 100 may store the content items in various orders, arrangements, and/or hierarchies. Content management system 100 may store the content items in a network accessible storage (SAN) device, in a redundant array of inexpensive disks (RAID), etc. Content management system 100 may store content items using one or more partition types, such as FAT, FAT32, NTFS, EXT2, EXT3, EXT4, ReiserFS, BTRFS, and so forth.

Data store 118 may also store metadata describing content items, content item types, and the relationship of content items to various accounts, folders, collections, or groups. The metadata for a content item may be stored as part of the content item and/or may be stored separately. Metadata may be store in an object-oriented database, a relational database, a file system, or any other collection of data. In one variation, each content item stored in data store 118 may be assigned a system-wide unique identifier.

Data store 118 may decrease the amount of storage space required by identifying duplicate files or duplicate chunks of files. Instead of storing multiple copies, data store 118 may store a single copy of a file 134 and then use a pointer or other mechanism to link the duplicates to the single copy. Similarly, data store 118 may store files 134 more efficiently, as well as provide the ability to undo operations, by using a file version control that tracks changes to files, different versions of files (including diverging version trees), and a change history. The change history may include a set of changes that, when applied to the original file version, produce the changed file version.

Content management system 100 may be configured to support automatic synchronization of content from one or more client devices 102. The synchronization may be platform independent. That is, the content may be synchronized across multiple client devices 102 of varying type, capabilities, operating systems, etc. For example, client device 102a may include client software, which synchronizes, via a synchronization module 122 at content management system 100, content in client device 102 file system 108 with the content in an associated user account. In some cases, the client software may synchronize any changes to content in a designated folder and its sub-folders, such as new, deleted, modified, copied, or moved files or folders. In one example of client software that integrates with an existing content management application, a user may manipulate content directly in a local folder, while a background process monitors the local folder for changes and synchronizes those changes to content management system 100. In some embodiments, a background process may identify content that has been updated at content management system 100 and synchronize those changes to the local folder. The client software may provide notifications of synchronization operations, and may provide indications of content statuses directly within the content management application. Sometimes client device 102 may not have a network connection available. In this scenario, the client software may monitor the linked folder for file changes and queue those changes for later synchronization to content management system 100 when a network connection is available. Similarly, a user may manually stop or pause synchronization with content management system 100.

A user may also view or manipulate content via a web interface generated and served by user interface module 104. For example, the user may navigate in a web browser to a web address provided by content management system 100. Changes or updates to content in the data store 118 made through the web interface, such as uploading a new version of a file, may be propagated back to other client devices 102 associated with the user's account. For example, multiple client devices 102, each with their own client software, may be associated with a single account and files in the account may be synchronized between each of the multiple client devices 102.

Content management system 100 may include sharing module 126 for managing sharing content and/or collections of content publicly or privately. Sharing module 126 may manage sharing independently or in conjunction with counterpart sharing module (e.g., 152a and 152b). Sharing content publicly may include making the content item and/or the collection accessible from any computing device in network communication with content management system 100. Sharing content privately may include linking a content item and/or a collection in data store 118 with two or more user accounts so that each user account has access to the content item. The sharing may be performed in a platform independent manner. That is, the content may be shared across multiple client devices 102 of varying type, capabilities, operating systems, etc. The content may also be shared across varying types of user accounts. In particular, the sharing module 126 may be used with the collections module 124 to allow sharing of a virtual collection with another user or user account. A virtual collection may be a grouping of content identifiers that may be stored in various locations within file system of client device 102 and/or stored remotely at content management system 100.

A virtual collection may be created with collection module 124 by selecting existing content items stored and/or managed by the file storage service and associating the existing content items within data storage (e.g., associating storage locations, content identifiers, and/or addresses of stored content items in collections database) with the virtual collection. By associating existing content items with the virtual collection, a content item may be designated as part of the virtual collection without having to physically store (e.g., by copying and pasting the content item file to a directory) the content item in another location within data storage in order to place the content item in the collection.

In some embodiments, content management system 100 may be configured to maintain a content directory or a database table/entity for content items where each entry or row identifies the location of each content item in data store 118. In some embodiments, a unique or a nearly unique content identifier may be stored for each content item stored in the data store 118.

Metadata may be stored for each content item. For example, metadata may include a content path that may be used to identify the content item. The content path may include the name of the content item and a folder hierarchy associated with the content item (e.g., the path for storage locally within a client device 102). In another example, the content path may include a folder or path of folders in which the content item is placed as well as the name of the content item. Content management system 100 may use the content path to present the content items in the appropriate folder hierarchy in a user interface with a traditional hierarchy view. A content pointer that identifies the location of the content item in data store 118 may also be stored with the content identifier. For example, the content pointer may include the exact storage address of the content item in memory. In some embodiments, the content pointer may point to multiple locations, each of which contains a portion of the content item.

In addition to a content path and content pointer, a content item entry/database table row in a content item database entity may also include a user account identifier that identifies the user account that has access to the content item. In some embodiments, multiple user account identifiers may be associated with a single content entry indicating that the content item has shared access by the multiple user accounts.

To share a content item privately, sharing module 126 may be configured to add a user account identifier to the content entry or database table row associated with the content item, thus granting the added user account access to the content item. Sharing module 126 may also be configured to remove user account identifiers from a content entry or database table rows to restrict a user account's access to the content item. The sharing module 126 may also be used to add and remove user account identifiers to a database table for virtual collections.

To share content publicly, sharing module 126 may be configured to generate a custom network address, such as a uniform resource locator (URL), which allows any web browser to access the content in content management system 100 without any authentication. To accomplish this, sharing module 126 may be configured to include content identification data in the generated URL, which may later be used to properly identify and return the requested content item. For example, sharing module 126 may be configured to include the user account identifier and the content path in the generated URL. Upon selection of the URL, the content identification data included in the URL may be transmitted to content management system 100 which may use the received content identification data to identify the appropriate content entry and return the content item associated with the content entry.

To share a virtual collection publicly, sharing module 126 may be configured to generate a custom network address, such as a uniform resource locator (URL), which allows any web browser to access the content in content management system 100 without any authentication. To accomplish this, sharing module 126 may be configured to include collection identification data in the generated URL, which may later be used to properly identify and return the requested content item. For example, sharing module 126 may be configured to include the user account identifier and the collection identifier in the generated URL. Upon selection of the URL, the content identification data included in the URL may be transmitted to content management system 100 which may use the received content identification data to identify the appropriate content entry or database row and return the content item associated with the content entry or database row.

In addition to generating the URL, sharing module 126 may also be configured to record that a URL to the content item has been created. In some embodiments, the content entry associated with a content item may include a URL flag indicating whether a URL to the content item has been created. For example, the URL flag may be a Boolean value initially set to 0 or false to indicate that a URL to the content item has not been created. Sharing module 126 may be configured to change the value of the flag to 1 or true after generating a URL to the content item.

In some embodiments, sharing module 126 may also be configured to deactivate a generated URL. For example, each content entry may also include a URL active flag indicating whether the content should be returned in response to a request from the generated URL. For example, sharing module 126 may be configured to only return a content item requested by a generated link if the URL active flag is set to 1 or true. Changing the value of the URL active flag or Boolean value may easily restrict access to a content item or a collection for which a URL has been generated. This allows a user to restrict access to the shared content item without having to move the content item or delete the generated URL. Likewise, sharing module 126 may reactivate the URL by again changing the value of the URL active flag to 1 or true. A user may thus easily restore access to the content item without the need to generate a new URL.

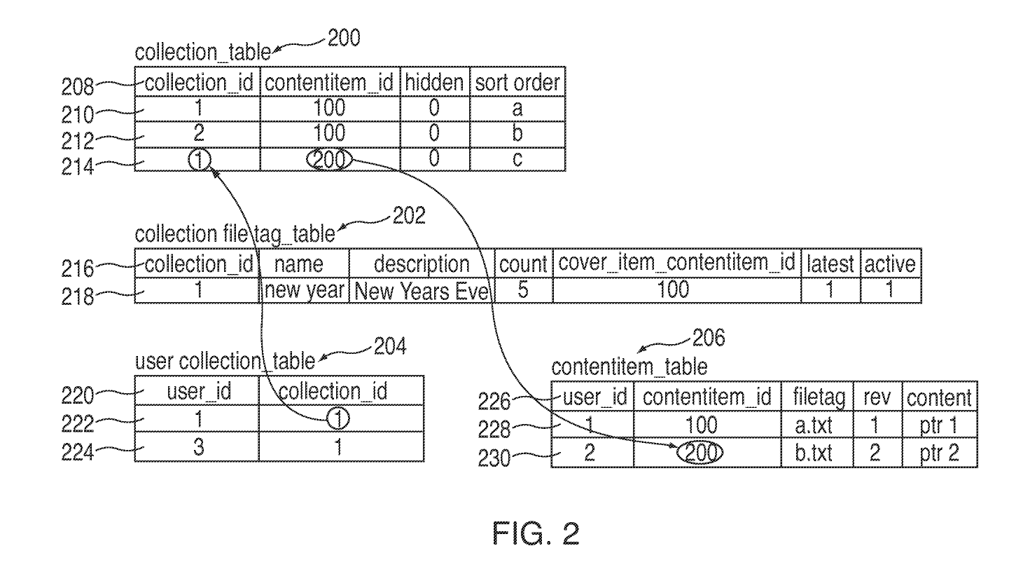

FIG. 2 depicts exemplary database entities 200-206 for presenting content items in a collections view in accordance with some embodiments. Database entities 200-206 can be used to store data that can define relationships between various content items, virtual collections, user accounts in addition to other suitable information and/or metadata within the storage of a content management system (e.g., collections module 132 of data store 118 of FIG. 1). Database entities 200-206 may be database tables that include columns that can represent fields for the database table and rows that can represent individual records of the database table. Each record in the database table may have one or more values for the database fields of the database table. Although examples provided throughout may refer to an entity as a database table, those skilled in the art will recognize that there are various ways an entity of a database design may be implemented. For example, while in a relational database, an entity may be a database table or view, in an object database, the entity may map to an object class.

Collections table 200 may be a database table stored within data store 118 of content management system 100 that associates content items with particular virtual collections. For this purpose, collections table 200 can include database fields illustrated at 208, namely: collection id, which can include records of various virtual collections; contentitem_id, which can include records of various content items; hidden, which can include records regarding whether a particular content item in a particular virtual collection should be displayed or hidden; and sort order, which can include records regarding the order in which content items should be displayed for a particular virtual collection. It should be noted that a content item can be part of multiple virtual collections. Thus, as depicted in FIG. 2, the content item denoted contentitem_id 100 can be part of the virtual collections denoted collection_id1 and collection_id 2.” Further, more than one content item can be associated with the same virtual collection. Accordingly, the content items denoted by contentitem_id 100 and contentitem_id 200 can both be associated with the virtual collection denoted as collection_id 1.

User collection_table 204 may be a database table stored within data store 118 that associates virtual collections with particular user accounts of a content management system. User collections_table 204 can include database fields illustrated at 220, namely: “user_id,” which can include records of various user accounts; and “collection_id” for each virtual collection identifier associated with the account. A collections module of a content management system (e.g., collections module 124 of FIG. 1) may be used to associate a virtual collection with a user account, and each row in user collection table 204 may designate an associated virtual collection and account. For example, a new row may be created when a new virtual collection is created for a user account or shared with a user account. For example, as depicted in row 202 of user collection table 204, a user account denoted by user_id 1 can be associated with a virtual collection denoted by collection_id 1. Similarly, depicted in row 224, the virtual collection denoted by collection-id 1 is also accessible to the user account denoted by user_id 3. Collection id 1 may have been shared by user_id 1 with user account with user_id 3, for example. Contentitem_table 206 may be a database table stored within data store 118 that associates content items with user accounts of a content management system. That is, the content items listed in contentitem_table 206 may be primarily associated with one user account, which may be the user account that updated the content item to the content management system, for example. Accordingly, the content item may be stored in a portion of data store 118 (e.g., files 134) that is apportioned for the user account.

Contentitem_table 206 may be related to collection_table 200 and/or user collection_table 204 that facilitates retrieval of content items associated with a virtual collection. Contentitem_table 206 can include database fields illustrated at 226, namely: user_id and contentitem_id, which can refer to the same database fields described above with respect to database entries 200 and 204; filetag, which can represent the name of a content item; revision, which can represent a particular version of a content item; and content, which may represent a reference, a file pointer, or a content pointer (e.g., as illustrated with “ptr2”) to at least a portion of the actual content item.

While content items may be stored in a portion data store 118 apportioned for a particular user account, other user accounts may have access to those content items under certain circumstances. For example, the content items may be shared directly between a first and second user account, or the content items may be made public or semi-public for other user accounts to access. Accordingly, as shown in row 230 of contentitem_table 206, contentitem_id 200 can represent a content item stored for user account with user_id 2. Now turning back to collection_table 200, contentitem_id 200 is part of a virtual collection associated with collection_id 1. Now referring back to user collection_table 204, collection_id 1 is accessible to user_id 1. Accordingly, a first user account (i.e., user_id 1) may have access to a content item stored for a second user account (i.e., user_id 2). That is, the content item, contentitem_id 200 stored in data store 118 for the account associated with user_id2 may be accessible as part of a virtual collection, collection_id 1, when user_id 2 designates the contentitem_id 200 as being shared with user_id 1, for example.

As indicated above, in some embodiments, sharing module 126 may create a row in collection_table 200 when a content item is shared between user accounts. Accordingly, sharing module 126 can reference user collection_table 204 to determine which collection_id(s) are associated with user_id 1. When it is determined that collection_id 1 is associated with user_id 1, sharing module 126 can created row 214 in collection_table 200 in order to associate contentitem_id 200 with collection_id 1 to designate that the contentitem_id 200 is shared with user_id 1. In the present example, a content item identifier was used to identify the content item. In other embodiments, a file tag (e.g., file path stored in filetag field of content item table 206) and revision (e.g., revision stored in rev field of content item table 206) may uniquely identify a content item.

Metadata may be stored for virtual collections and content items within a collection, and the metadata may be retrieved or accessed using the API. For example, collection metadata table 202 may contain metadata for a virtual collection, including, but not limited to, a collection name (e.g., “new year” in row 218), a description (e.g., “New Year's Eve” in row 218), a content item count (e.g., “5” in row 218), a cover item/visual representation for the collection (e.g., a thumbnail or visual representation for the collection as identified with the content item identifier “100” in row 218, a Boolean value indicating whether the metadata is the latest metadata (e.g., “1” indicating true in “latest” database field in row 218), a Boolean value indicating whether the collection is active (e.g., “1” indicating true in “active” database field of row 218), an update time, a creation time, a share link, and/or any other metadata. Metadata stored for each content item of a virtual collection can include, but is not limited to, a sort key or category for the content item, a type of content item, an update time, a visual representation, a hash key for the visual representation, a path for storage of the content item within local storage of a client device, a revision identifier for the content item, a list of any other files related or similar to the content item, and/or any other metadata for the content item. A list of related or similar content items stored within data store 118 of content management system 100 may have the same primary or root file. For example, any file that is a copy, a variation, or detected as similar to a particular file or primary file stored in the data store 118 may be stored in such a list.

An index may be created for a database column or field of a database table to optimize the retrieval of data. In a preferred embodiment, use of the index may allow for retrieval of data without a full scan of a database table and/or a full scan of data accessible. Indexes may be created for the entire database column (e.g. for all data rows) and/or for a portion of the database column (e.g. a subset of data rows). For example, the index may be created for a subset of values for a column of a database table that are for a particular user account or a collection.

A database cursor may be used to keep track the current state for content items locally stored on a client device within the file system of the client device and/or cache of the client device. For example, the database cursor may point to a row in a database for a revision of a virtual collection that is currently stored within a cache on a client device. With knowledge of the cached version of the collection, updates to the virtual collection and/or content items within the collection can be sent to the client device.

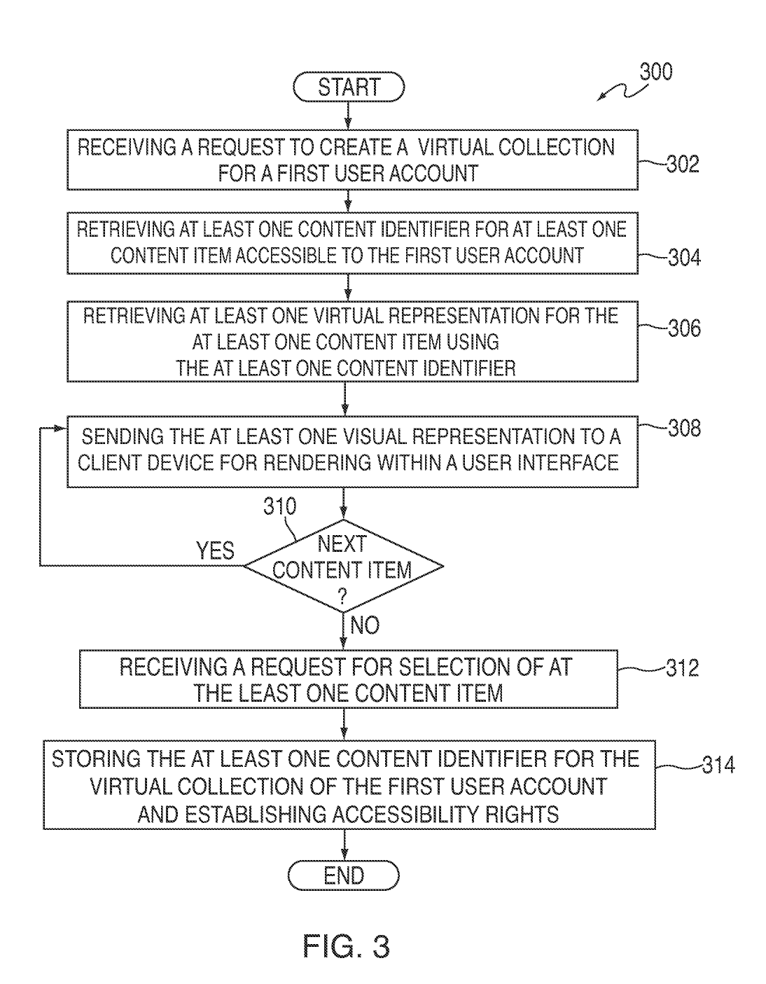

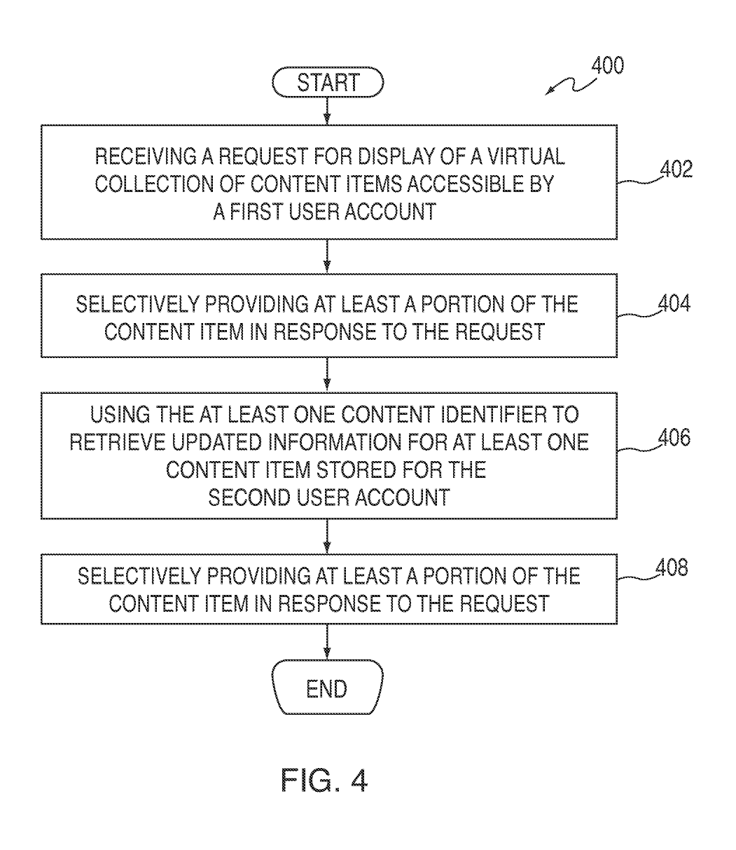

FIG. 3 is a flowchart of an illustrative process 300 for presenting content items using a collections view, in accordance with some embodiments. Process 300 may begin with a request being received to manage a virtual collection for a first user account registered with a content management system (e.g., content management system 100 of FIG. 1) (302). Management of a virtual collection by a user may include creating the virtual collection, updating an existing virtual collection, deleting content items from a virtual collection, and/or any other management of the virtual collection desired by a user. For example, the user of a first client electronic device 102a may interact with the user interface of file storage application 114a or client application implemented with interface module 104 to request creation of a virtual collection. If the user desires to modify or receive updates for an existing virtual collection (e.g., by adding new content items), the virtual collection may be retrieved for display on the client device (as described in FIG. 4).

Process 300 can continue with at least one content identifier for at least one content item accessible to the first user account being retrieved (304). Content items stored within content management system 100 that are accessible to first user account may be retrieved to facilitate management of a virtual collection for the first user account. Content items accessible for an account may include, for example, content items stored locally within file system 108a on first client electronic device 102a, content items stored remotely in data store 118 of content management system 100 for first user account, and/or content items stored remotely with content management system 100 that are shared with the first user account from one or more other user accounts registered with content management system 100. Access rights may further specify the read and write access for content items.

According to some embodiments, a content item may be stored within data storage 118 of content management system 100 for a second user account, and the content item may be accessible to the first user account because the content item was shared from a second user account (e.g., using a sharing module such as sharing module 126 of FIG. 1). By way of example, a second user account may upload a file 110b from file system 108b of second client device 102b to data store 118 and then share file 110b with first user account. The shared file may be stored within a portion of data store 118 apportioned for the second user account, and shared with the first user account using various methods provided by the sharing module 126. In some embodiments, sharing module 126 may indicate in metadata stored for a content item within the data store 118 that the content item (e.g., file 110b) is accessible to first user account. An implementation of sharing content items is described in U.S. patent application Ser. No. 13/596,735, entitled “Uploading one or more Files from a Shared File Link,” which is incorporated herein by reference.

At least one visual representation for the at least one content item can then be retrieved using the at least one content identifier (306). The visual representation may be a thumbnail image, any other suitable representation of the content item, or the actual content item stored within data store 118. Visual representations for a retrieved content item may then be sent to a client device to be rendered within a user interface (308). At least one content item rendered within the user interface may be a content item that was stored for a second user account and shared with a first user account. Visual representations may be stored in the cache of client device, and a hash key may be sent for retrieval of the visual representation from the cache for display on the user interface at the client device. According to some embodiments, visual representations may be stored as one or more file segments that may be retrieved using the hash key and may be displayed within the user interface along with a user interface control for optional selection of content items for the virtual collection for first user account.

In some embodiments, a decision may be made as to whether to flatten the file system hierarchal structure for display of content items in the user interface for selection for a virtual collection by first user account. If the decision is made to present the hierarchical structure of the file system 108a, information regarding the hierarchical structure may be retrieved for each content item accessible to first user account to display content items for selection within the hierarchical structure. Accordingly, content management system 100 can store information regarding the file system hierarchy (e.g., file path data) for files stored within file system 108a on first client electronic device 102a and can provide the information on the hierarchical structure for display of the content items for selection within the user interface. On the other hand, if a decision is made to flatten the hierarchical structure, then content items may be displayed in the user interface without maintaining the hierarchical structure. Thus, metadata including the file path for the content item may not need to be retrieved for each content item accessible by the first user account.

In some embodiments, categories or subsets of content items may be retrieved using the API. For example, content identifiers may be retrieved for content items that that are images or images within a particular directory (e.g., “Photos” directory on client device). In another example, content items (e.g., images) may be further categorized by topic, data, or any other metadata that allows for sorting content items and retrieving particular content items falling into the category. Continuing with the example, content identifiers may be retrieved for content items that are categorized with a particular description (e.g., “New Year's Eve” or “outdoor photos”).

Continuing with process 300, the retrieved content items may be returned in a list, a dictionary, an array, or any other data structure that can facilitate iterative processing of the retrieved content items. Because each content item accessible to first user account may be available for rendering within a user interface, the content management system can iteratively proceed through the retrieved content items while there are additional content items desired to be sent (310). A visual representation of each retrieved content item can be sent to client device for rendering within the user interface (308). When no more content items are available for sending to the client device (310), iteration through the retrieved content items may stop.

In some embodiments, visual representations for content items may be sent to the client device in a piecemeal fashion and/or using predictive techniques. Accordingly, rather than sending all available visual representations at once, a subset of visual representations may be sent to the client device with the number of visual representations sent calculated as a function of the number that can be rendered within the user interface, the size of a cache memory of the client device, and/or the bandwidth available for communications between the content management system and the client device. The subset of visual representations sent to the client device can, therefore, include the number of visual representations that can be rendered in the user interface at one time in addition to a number of un-rendered visual representations that may be physically close to the rendered visual representations (e.g., those that would be rendered before or after the current set of visual representations displayed in a scrollable gallery view of the visual representations). In another example, the content management system may predict when visual representations may be needed for display on the user interface using a learning algorithm that can predict and/or learn how many visual representations should be made available for display on the client device to ensure that the number of visual representations required for seamless viewing of visual representations in the user interface is available in the cache memory of the client device.

Continuing with process 300, a request may be received for selection of at least one content item rendered within the user interface for incorporation in the virtual collection for the first user account (312). The at least one content item selected may include, among other content items accessible by the first user account, content items stored and/or associated primarily with the second user account. The user may indicate the request using a selection user interface that includes the visual representations of the retrieved content items provided on the client device.

After at least one content item is selected for incorporation within the virtual collection for the first user account, a content identifier for each of the content items may be associated with the virtual collection of the first user account (314). The content identifiers for the selected content items can be associated with virtual collection identifiers in a database such as collection_table 200, for example. The content identifier may identify the at least one content item stored within the virtual collection and allow for retrieval of the content item from a storage location within content management system even if the content item is located in a storage location reserved, allocated, and/or authorized for the second user account. Accessibility rights for the second user account may be established for the content item and/or the virtual collection.

By storing the content identifier with the virtual collection, changes made to the content item by users of the first user account and/or the second user account may be reflected for the content item retrieved using the virtual collection. For example, if a user modifies a file and/or moves a file within the hierarchy of the local file system on second client electronic device 102b, the content identifier stored within attributes 112 may allow for identification of the moved/modified file by content management system 100. Any changes (e.g., edits) made to the moved file within the local file system of second client device 102b may be uploaded to content management system 100 (e.g., during a synchronization process) in accordance with accessibility rights established for the user accounts. In this way, the changes made to the file locally stored on the second client electronic device 102b may be reflected and present in the synchronized file displayed within the virtual collection.

In some embodiments, entire virtual collections may be selected for inclusion in another virtual collection. A first virtual collection identifier may be associated with a second virtual collection identifier (e.g., stored in a database table) to indicate or designate inclusion within the first virtual collection.

FIG. 4 depicts a flowchart of an illustrative process 400 for presenting content items using a collections view in accordance with some embodiments. A request may be received for display of a virtual collection of content items by a first user account (402). A virtual collection identifier may be used to retrieve content items associated with a particular virtual collection accessible by a first user account. Alternatively, all virtual collections accessible by a particular user account may be requested, and/or a particular category of virtual collections may be retrieved. Metadata for a particular virtual collection may be retrieved that includes, but is not limited to: a visual representation for the collection, a count or number of content items in the virtual collection, a description, and/or any other data stored for the virtual collection. Metadata may be used for display of the virtual collection within a user interface presented on the display of a client device (e.g., a count can be used to properly size widgets of a user interface for display of content items) and/or metadata may be displayed within the user interface (e.g., a description for the virtual collection).

At least one content identifier stored for the virtual collection may be retrieved (404). The at least one content identifier retrieved may represent all content identifiers for the virtual collection or a subset of content identifiers for the virtual collection (e.g., content identifiers associated with a category of content items).

At least one content identifier retrieved may be used to retrieve at least a portion of the content item (406). In some embodiments, the at least one content identifier may retrieve at least a portion of the content item from a data store of the content management system, including from a storage location reserved, allocated, and/or authorized for use by a second user account if the content item is part of the virtual collection accessible by the first user account. The entire content item and/or a portion of content, such as a file segment of a content item, stored in the data storage for the second user account may be retrieved with the content identifier. The content item may be accessible to the first user account in accordance with access control rights/privileges provided to the first user account.

In some embodiments, the content item may be a version and/or a file from local storage of a second user client device that is synchronized and uploaded to content management system. The updated content item may be stored for the second user account and accessible by the first user account using the content identifier. The updated content item may be selectively provided in accordance with accessibility rights designated for the user account for the content item. Updates may be provided to users for the virtual collection if the user account used to make the updates has read/write privileges to the content item/virtual collection and/or the content item is shared with the user account.

In some embodiments, the portion of the content item retrieved may represent a recent update to the content item with a second user account. For example, if a content item is cached on the client device, only modifications or changes to the content item that were made since the content item was cached may need to be sent to the client device. In another example, the portion of the content stored for the second user account may be a modification to a file made by the second user account that may be combined with a file provided by another user account. In other embodiments, the entire content item may be retrieved.

The portion of the content may be sent in response to the request to the client device (408). The content may be sent to the client device and stored in the cache of client device. A hash key may be sent to the client device to allow the content item to be retrieved for display within a user interface.

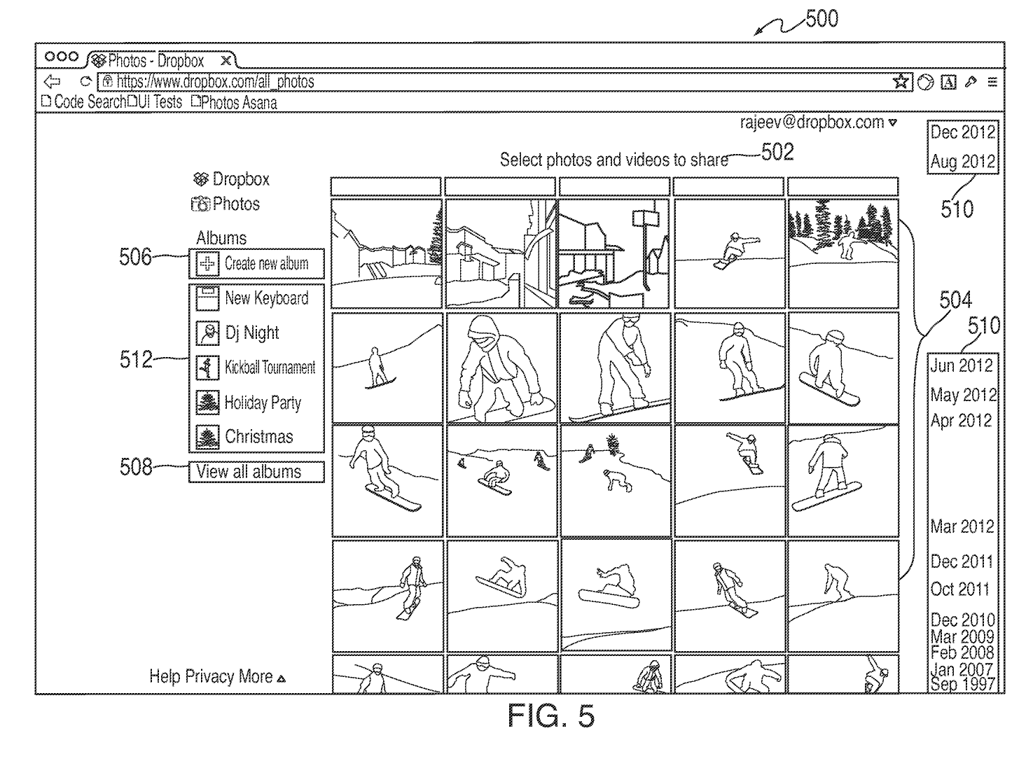

FIGS. 5-8 depict illustrative user interfaces for presenting content items using a collections view, in accordance with some embodiments. FIG. 5, in particular, depicts a user interface 500 illustrating a flattened view of a hierarchical structure of content items 504 uploaded from file system 108 of a client device 102 and stored within data store 118 of content management system 100. Content items 504 may be displayed in any suitable order within user interface 500 (e.g., in accordance with the time the content item was created). Additionally, a timeline 510 can be displayed within user interface 500 to indicate the time associated with each content item. Creation time may be stored as metadata with each of the content items within data store 118 of content management system 100, and an API may allow for retrieval of the metadata associated with each content item to enable creation of the timeline.

As indicated by user interface title 502, “Select photos and videos to share,” a user authorized for first user account may submit a request to “Create a new album” (i.e., a new virtual collection) with user interface element 506. In some embodiments, user interface element 506 may be a link to another web page. The user may also be provided with additional user interface elements 512 for selecting to display and/or add content items to particular existing virtual collections and/or a user interface element 508, “View all albums,” for selecting to display all existing virtual collections categorized as albums. The API may allow for requesting retrieval of a particular collection and/or categories of collections (e.g., by file type, description, or any other sort key).

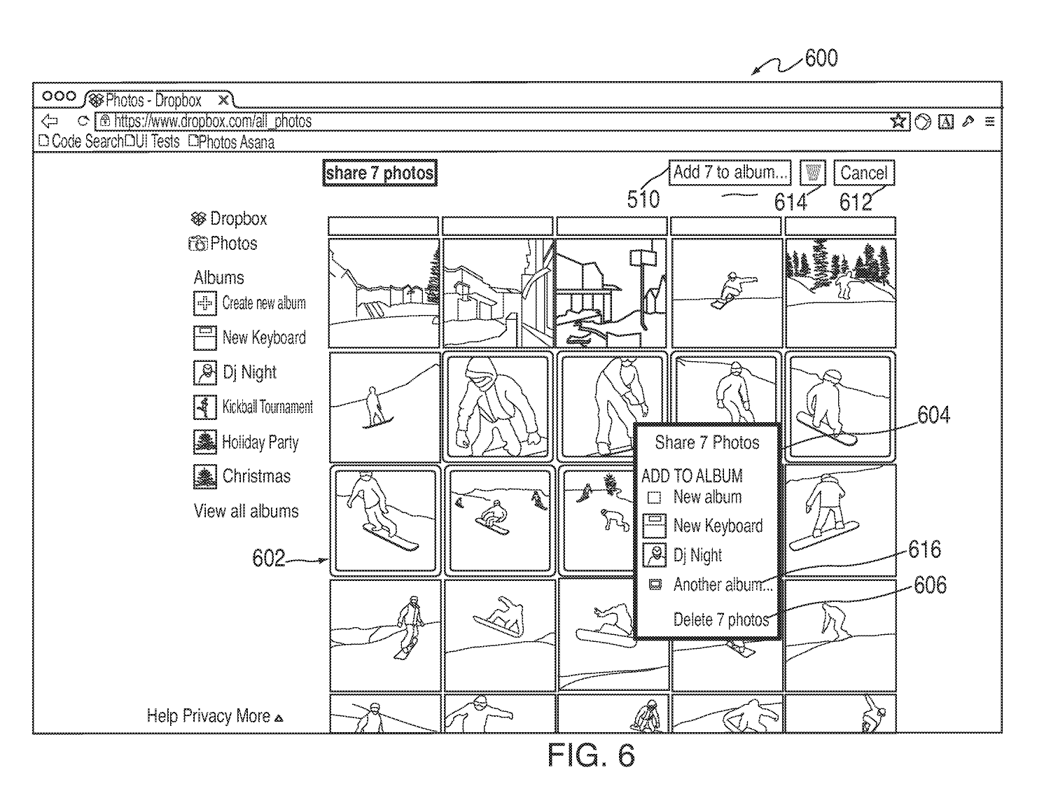

FIG. 6 depicts an illustrative user interface 600 for presenting content items using a collections view in accordance with some embodiments. User interface 600 can illustrate selection of content items with highlighted content items 602. A selection user interface element 604 can be rendered in user interface 600, and the selection user interface control may facilitate the creation of a virtual collection with a user interface control 616 titled “Another album . . . ” located with selection control 604. The API provides the ability for a user to create a new collection and include the selected image 602 in the collection.

A user interface element 606 titled “Delete 7 photos” may be provided within selection control 604 for allowing a user to delete selected content items 602. Thus, the API may provide a user with the ability to delete selected content items 602. For example, the API can provide metadata for each content item that includes a list of all related files (e.g., copies or alternate versions of the file within data storage) to a particular content item, and a programmer may use the API to allow for deletion of a list of the seven selected files 602 as well as all files related to each of the selected files. This process may be used to permanently delete the files and all related files. In some embodiments, related files may all share the same content identifier, for example. Such files may be distinguished using a revision tag, such as the revision tag disclosed above with respect to contentitem_table 206 of FIG. 2.

An additional user interface control 608 titled “Share 7 photos” can be provided within user interface 600 for sharing photos with another user account. For instance, and as indicated above, collection module 124 may be used to create a virtual collection, and sharing module 126 may be used to share the virtual collection. Similarly, user controls may be provided for adding selected content items 602 to a virtual collection with user interface control 610 titled “Add 7 to album . . . ,” user interface control 614 may be provided for allowing the user to delete selected content items 602, and user interface control 612 may allow user to cancel selection of content items 602.

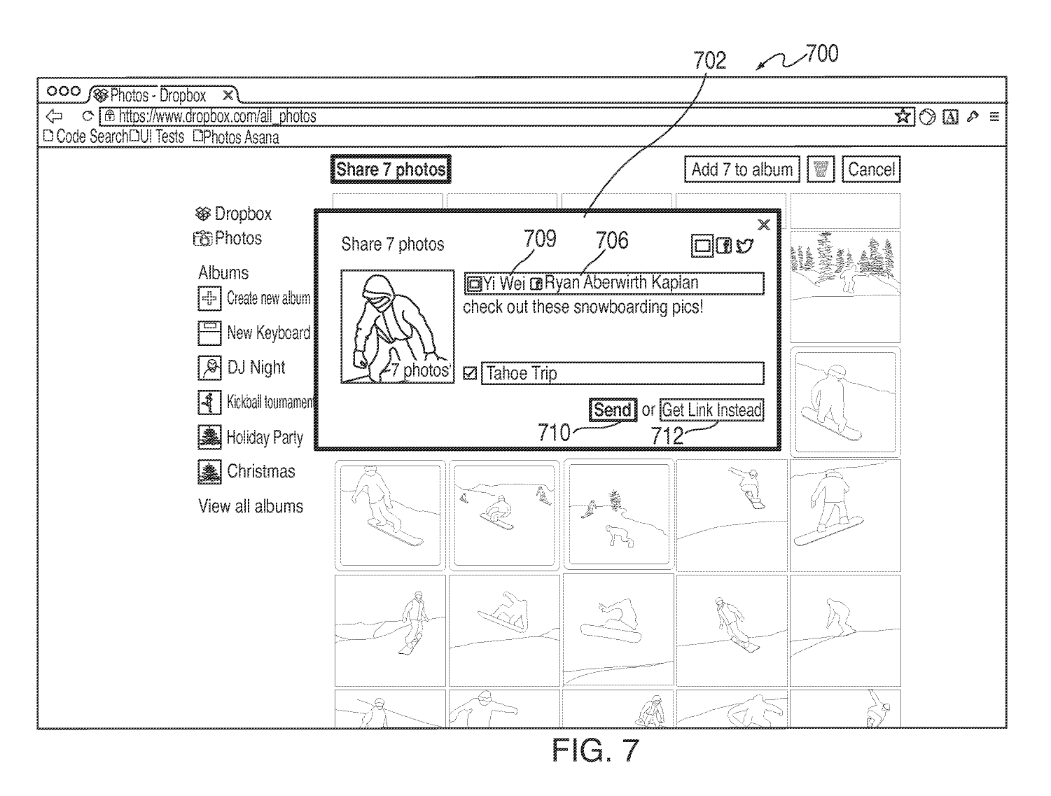

FIG. 7 depicts an illustrative a user interface 700 for presenting content items using a collections view in accordance with some embodiments. In particular, user interface 700 shows how a user with an account may share selected content items 602 with another account. As illustrated, a user may use user interface element 702 to create a link to share selected content items 602 to another user account. The link may be shared via any suitable communications protocol, such as by e-mail (704) or Facebook (706), for example. Optionally, a user may indicate a title for shared content in text box 708. The user may send the link using element 710 or receive a copy of a link using element 712.

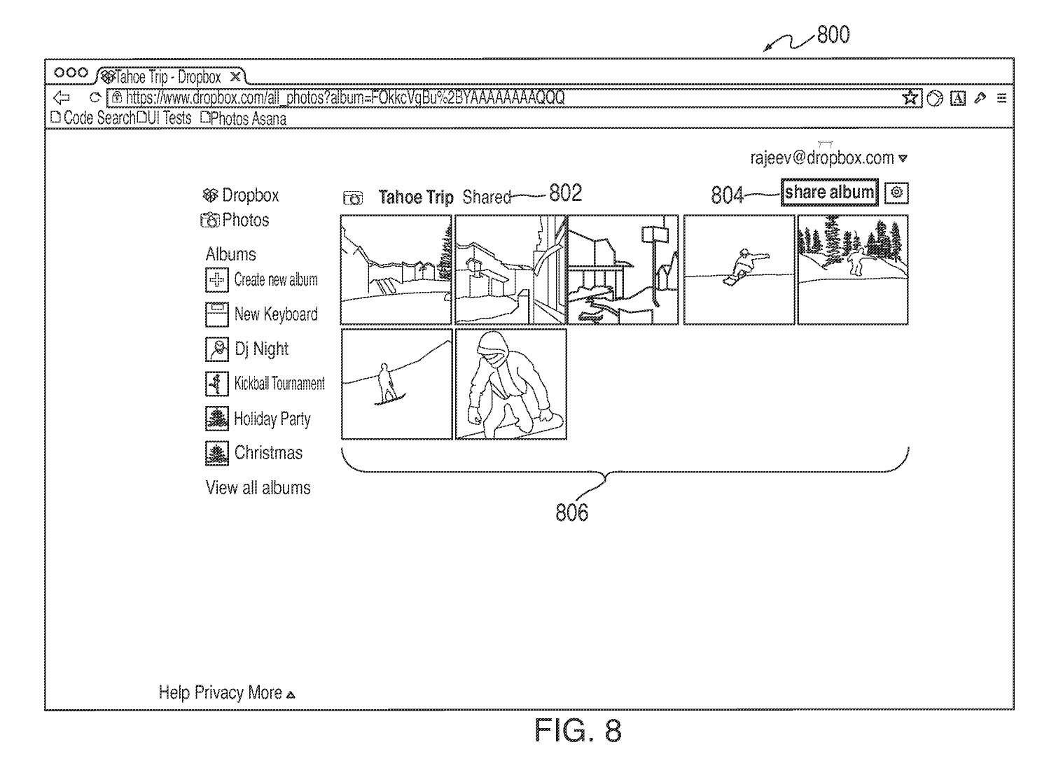

FIG. 8 depicts an illustrative user interface 800 for presenting content items using a collections view in accordance with some embodiments. User interface 800 illustrates a virtual collection 806 titled with name 802 as “Tahoe Trip.” Name 802 may be provided as metadata along with the virtual collection. User interface 800 can also provide a user interface element 804 for sharing the virtual collection.

In some embodiments, an authenticated first user account may be able to view a collection that is shared by a second user account. The second user account may add content items to the collection that are not otherwise available or accessible to the first user account. For example, the second user account may add a content item to a virtual collection without the content item being directly shared with the first user account.

The second user account may define access rights and permissions for particular content items within a shared collection, subsets of content items within a shared collection, and/or any other level of granularity for setting access rights for content items that are added to a shared collection and not otherwise accessible to the first user account. For example, a first user account may have read-only access rights to a content item that is accessible to the first user account by virtue of the shared collection. Continuing with the example, permissions or access rights may need to be granted by the second user account to allow the first user account to download the content item that is only accessible to the first user account within the shared collection. Further, depending on the defined permissions, users using different user accounts may collaborate on editing, modifying, adding content items, deleting content items, and/or any other functions to manage the shared collection. Accordingly, the first user account may be able to delete a content item from the shared collection that is only shared with the first user account by virtue of belonging to the shared collection.

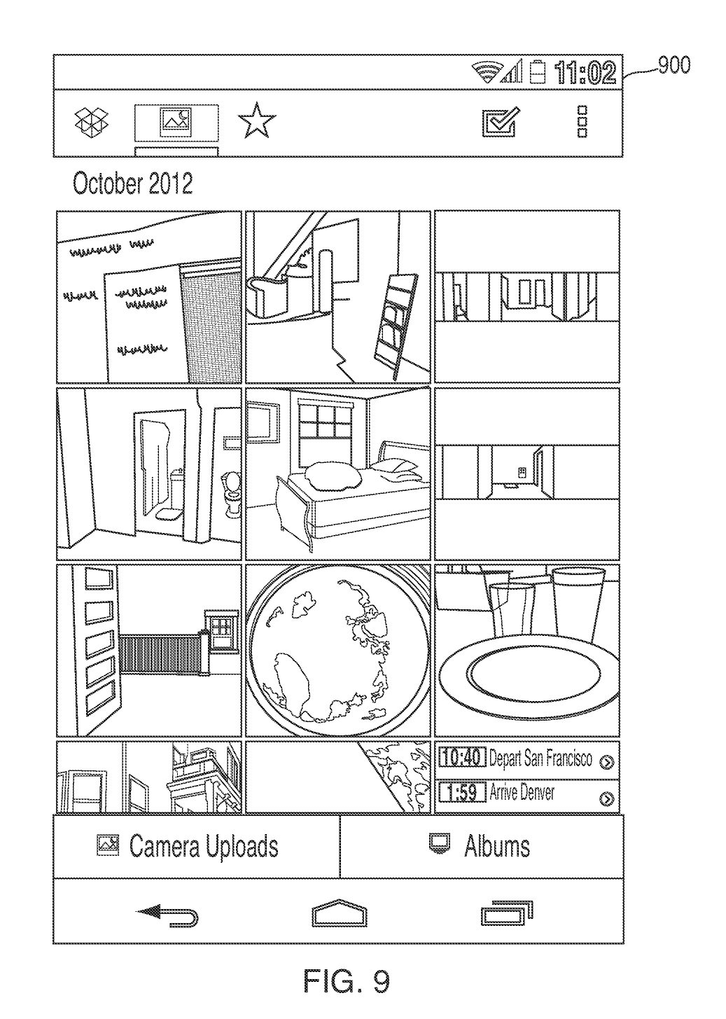

FIG. 9 depicts an illustrative user interface 900 for presenting content items using a collections view, in accordance with some embodiments. User interface 900 may provide a display of content items accessible to a user for building a collection and/or sharing a subset of content items. For example, a user may select “All Photos” that are accessible to the user, a category of content items, such as content items from “October 2012,” and/or a collection of content items.

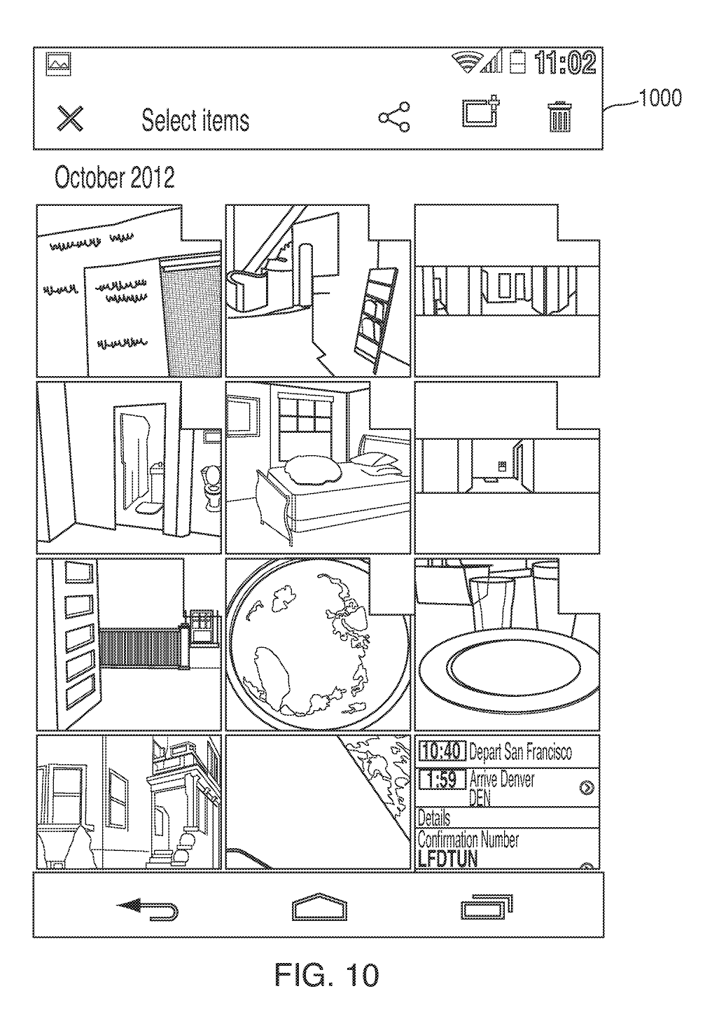

FIG. 10 depicts an illustrative user interface 1000 for presenting content items using a collections view, in accordance with some embodiments. User interface 1000 provides a display of content items that may be selected for sharing and/or building a collection.

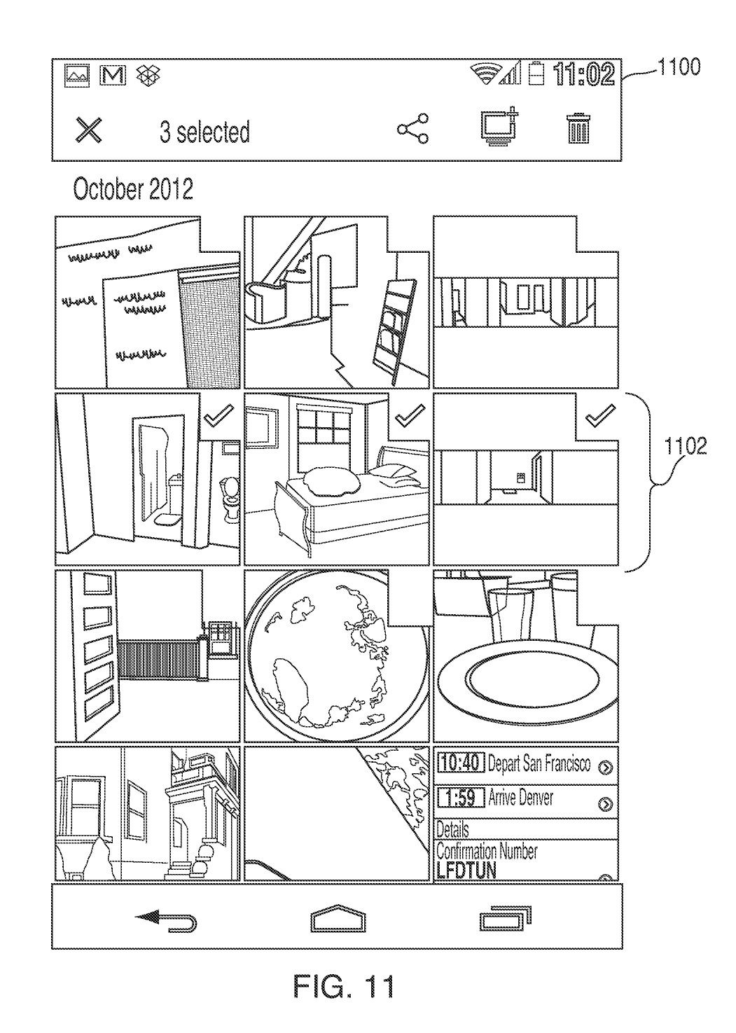

FIG. 11 depicts an illustrative user interface 1100 for presenting content items using a collections view, in accordance with some embodiments. In particular, user interface 1100 may illustrate a set and/or a subset of content items selected (depicted as highlighted and with a check mark icon) by a user from the displayed content items. In some embodiments, the selected subset of content items may be stored as an implicit collection. The implicit collection may be a collection that has a subset of metadata associated with the implicit collection and/or temporarily not entered by the user. For example, the implicit collection may not have a description and/or name provided by a user. In other embodiments, the implicit collection may be created purely as a mechanism to share particular content items with another user and may be intended to be stored temporarily, for a particular amount of time designated by the user, and/or any other amount of time.

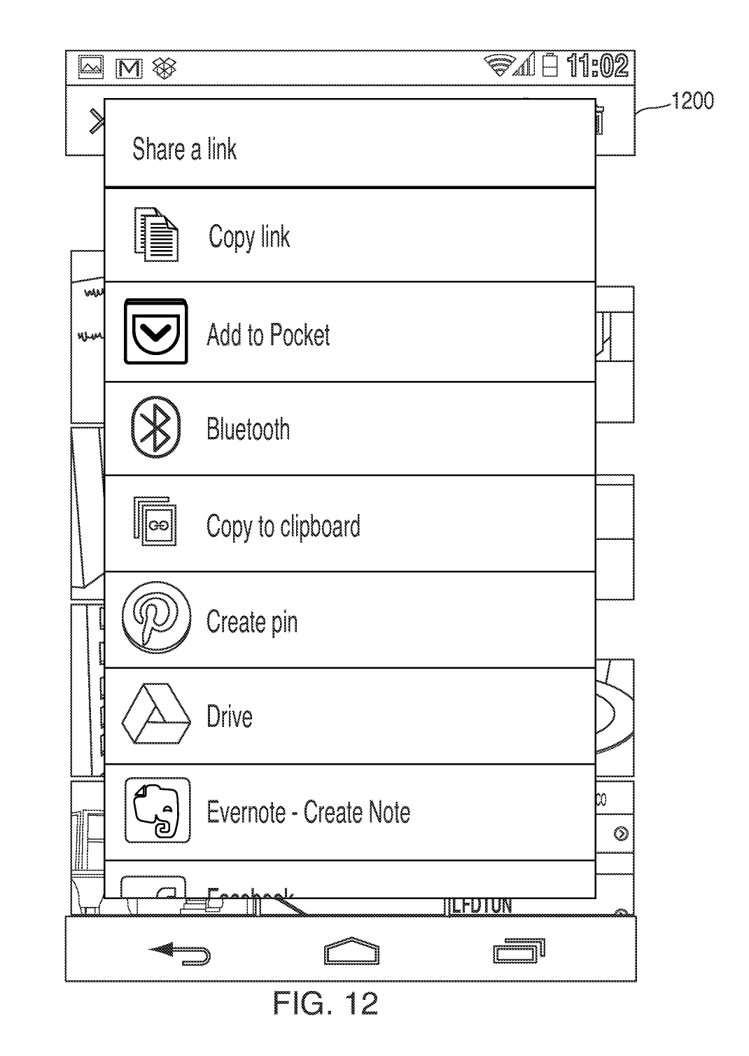

FIG. 12 depicts an illustrative user interface 1200 for presenting content items using a collections view, in accordance with some embodiments. In particular, user interface 1200 may provide various options for sharing an implicit collection (e.g., an implicit collection as described above with respect to FIG. 11). The implicit collection may be shared with a link accessible for use with a third-party application, Bluetooth, copied to a clip-board, uploaded to a third party web application (e.g., “Pinterest”), uploaded to a remote drive or any other remote storage, incorporated into a document or for use with an editor, and/or provided for use with any other application.

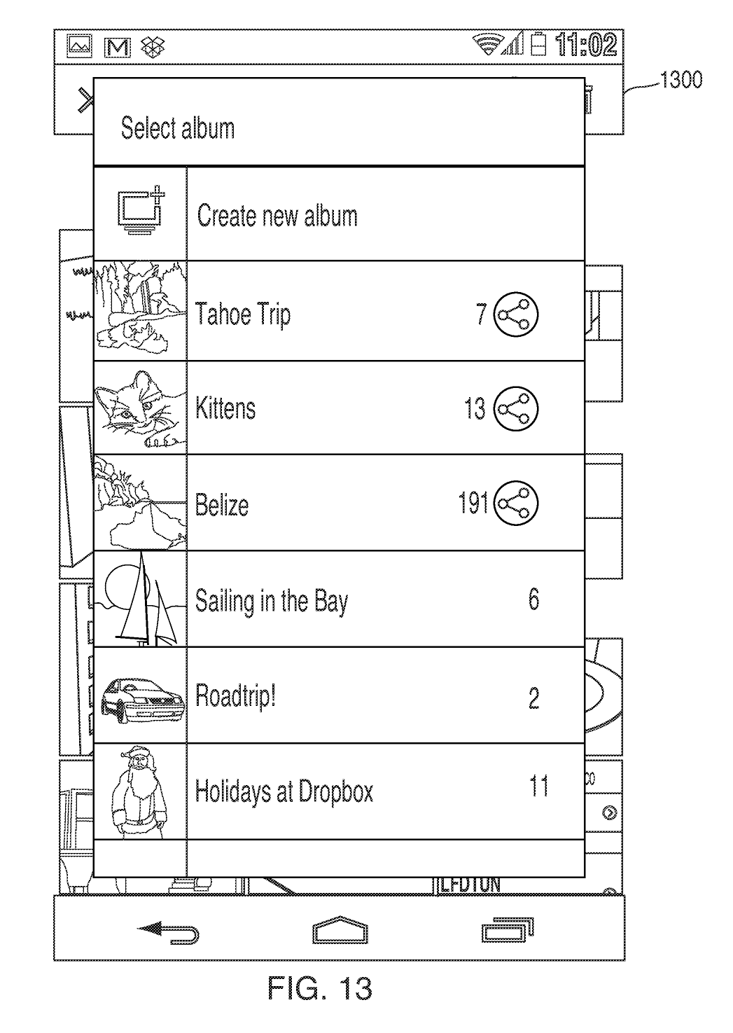

FIG. 13 depicts an illustrative user interface 1300 for presenting content items using a collections view, in accordance with some embodiments. In particular, user interface 1300 may provide a list of virtual collections (e.g., “Albums”) accessible to the user. In some embodiments, the virtual collections listed in user interface 1300 may be viewed as “explicit collections” and may be stored with particular metadata (e.g., title, description) by the user and/or designated as collections for display the user. Any implicit collections available to the user account may be converted into an explicit collection when a user has provided particular metadata and/or explicitly designated that the implicit collection be displayed with “explicit collections.”

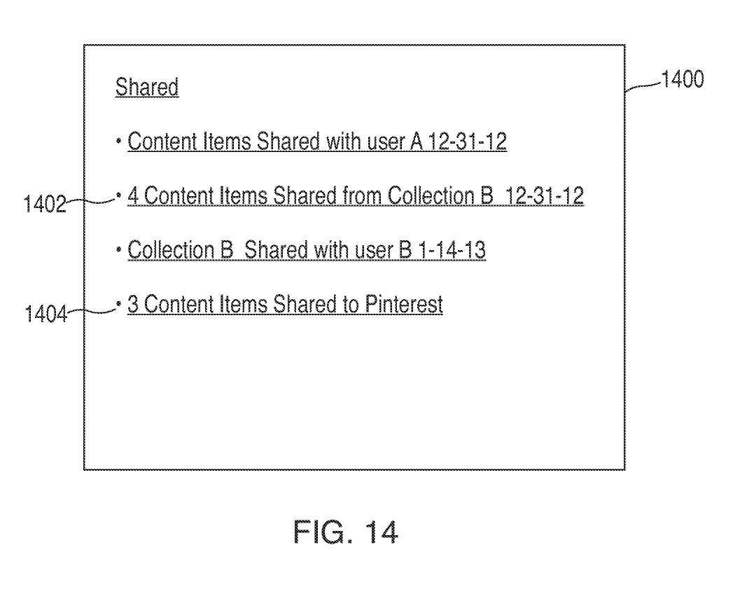

FIG. 14 depicts an illustrative user interface 1400 for presenting content items using a collections view, in accordance with some embodiments. In particular, user interface 1400 may provide a display of shared implicit collections. Implicit collections may be displayed by date and time shared, by a description of what was stored, by a description of user or application implicit collection was shared with, and/or any other description. As depicted in user interface 1400, implicit collection 1402 can include a count of the a subset of content items (e.g., 4) shared from a particular collection (e.g. Collection B). Implicit collection 1404 can also include a set of content items shared uploaded to a third-party web application.

Collections API

As indicated above, interface module 104 may have a collections API.

Collection Metadata

Collections API may allow for retrieval of metadata for a virtual collection. Metadata for a collection may be returned from an API function as a list or dictionary including, but not limited to, the following metadata: an identifier for the virtual collection, a creation time, an update time, a name for the collection, a creation time, a cover file record (e.g., thumbnail or visual representation for the collection represented with a record that contains a hash key for retrieval of the visual representation from the cache and/or content identifiers for the visual representation within data store, such as a path and a revision for the visual representation), and a share link (e.g., a URL produced by the sharing module 126 for retrieval of the collection). A sample record within the list as follows:

{

“count”: 1,
“update time”: “2012-12-10T22:52:14.890000Z”,
“name”: “Dolores Park”,
“creation_time”: “2012-12-10T22:52:01.335000Z”,
“cover_file”: {

“file_hash”:

“Z0d6mQDdzyqUkYkxNECUG3kSqxRbSkOigsB5nqkdH-w”,

“path”: “/Camera Uploads/2012-12-09 16.30.46.jpg”,
“rev”: “4a1087b046a”

},
“id”: “QCSjBD3FYC0AAAAAAAAODg”,
“share_link”:

“https://www.dropbox.com/sc/7ja88k6qvepuips/DVXPKv6S-O”,

}

Collection Item Metadata

Collections API may allow for retrieval of metadata for content items of a virtual collection. Metadata for content items from a collection may be returned from an API function as a list or dictionary including, but not limited to, the following metadata: an identifier for the content item, a sort key to sort items within the collection, an update time, a cover file (e.g., thumbnail with a hash key for retrieval of the cover file from the cache and identifiers for the thumbnail within storage with a path and a revision for the thumbnail image), and/or a list of related files to the content item (e.g., an empty list or list of files). A sample record within the list as follows:

{

“id”: “0”,
“update_time”: “2012-12-10T22:52:03.115000Z”,
“sort_key”: “---0Ds108j-7TkGey9KyDsbSRXH9Lq1C”,
“cover_file”: {

“file_hash”:

“j3l0UtZ0njuGMeNuUhf1n3VSD86YDIUA72o6QZRImC0”,

“path”: “/Camera Uploads/2012-12-09
16.30.46.jpg”,
“rev”: “4a1087b046a”

},
“other_files”: [ ]

}

Collections All Photos

Collections API provides for retrieval of a list of all photos or image type content items accessible by a user account that may be added to collections. Collection Item Metadata may be returned with a function for retrieving all photos accessible for creation of a collection.

Collections All Photos Delta

Collections API provides a function for retrieval of all changes to the photos retrieved by a user. A cursor used to keep track of the user's state may be passed in as a parameter to a function to retrieve changes to photos or image type content items. A parameter to limit the number of changes returned by the function may be provided when the function is called.

Collections Retrieval

Collections API provides the ability to retrieve a list of all collections for a user account. Optionally, the list of collections may be limited by providing a parameter to the function with a particular collection type or sort key. Collections API provides the ability to retrieve a particular collection. Collections API provides the ability to receive list of changes to collections and collection content items (e.g., metadata). A cursor may be passed as a parameter to retrieve changes to the collection and a limits to the received changes by collection and total limit.

Collection Management

Collections API provides the ability to create a collection, update a collection, delete a collection, share a collection, remove sharing of a particular collection or all collections, add to a collection, and remove content items from a collection.

Any suitable programming language can be used to implement the routines of particular embodiments including C, C++, Java, JavaScript, Python, Ruby, CoffeeScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time

Particular embodiments may be implemented in a computer-readable storage device or non-transitory computer readable medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described collections and methods for presenting collections thereof, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed is:

1. A method for presenting content items using a collections view, the method comprising:
receiving a request for display of a virtual collection of content items by a first user account with a content management system;
retrieving at least one content identifier stored for the virtual collection, wherein the at least one content identifier identifies at least one content item in data storage;
retrieving, using the at least one content identifier, updated information for the at least one content item comprising at least one of an updated location within a file system hierarchy and a modification to the at least one content item by a second user account; and
selectively providing an updated content item for display with the virtual collection in accordance with accessibility to the content item permitted by the second user account.

2. The method of claim 1, further comprising:
retrieving, using the at least one content identifier, a list of related content items comprising the updated content item and a version of the content item; and
selectively providing at least one of the updated content item and the version of the content item.

3. The method of claim 1, further comprising:
sending a content item from the virtual collection accessible for the second user account for storage on a device;
detecting a new storage location within the file system hierarchy on the device for the content item of the virtual collection;
obtaining the content identifier from metadata of the content item;
storing the new storage location with the content identifier within data storage;
detecting a modification to the content item stored;
retrieving accessibility information for the content item for the second user account;
selectively storing information on the updated content item with the content identifier; and
providing, upon request by the first user account, the updated content item for display with the virtual collection.

4. The method of claim 1, further comprising:
retrieving the at least one content identifier stored for the virtual collection, wherein the content identifier identifies the content item in a database table;
retrieving at least one content pointer associated with the at least one content identifier, wherein the at least one content pointer comprises an address to a storage location within data storage for at least a portion of the content item; and
accessing at least the portion of the content item at the storage location using the at least one content pointer, wherein the portion of the content item is stored in data storage for use by the first and second user accounts.

5. The method of claim 1, wherein accessibility to the content item by the second user account is determined by at least one of: (1) the content item is designated as shared with the second user account, (2) accessibility information for the content item indicates read and write privileges for the content item for the second user account, and (3) accessibility information for the virtual collection containing the content item indicates read and write privileges for the second user account.

6. The method from claim 1, the method further comprising:
receiving a request for metadata for the virtual collection of content items;
retrieving a virtual collection identifier identifying the virtual collection;
retrieving metadata associated with the virtual collection identifier, wherein the metadata for the virtual collection comprises at least one of a number of content items, a creation date, a revision date, a name, a description, a visual representation, and a share link;
retrieving metadata associated with the at least one content identifier stored for the virtual collection, wherein the metadata for the at least one content item comprises at least one of a sort key, a content item identifier, a visual representation, a hash key for the content item, a file path, and a content item identifier for a related content item; and
sending retrieved metadata for the virtual collection and retrieved metadata for the at least one content item to a client device.

7. The method from claim 1, further comprising:
sending a hash key for retrieval of at least a portion of the content item from a cache of a client device, wherein the portion of the content item comprises a file segment of an image file.

8. The method of claim 1, further comprising:
receiving a request to share the virtual collection with a third user account; and
providing a sharing link for the virtual collection to the third user account.

9. A system for presenting content items using a collections view, the system comprising:
one or more processors; and
memory containing instructions that, when executed, cause one or more processors to:
receive a request to create a virtual collection for a first user account with a content management system;
retrieve at least one content identifier for at least one content item accessible to the first user account;
retrieve at least one visual representation for the at least one content item using the at least one content identifier;
send the at least one visual representation to a device for rendering within a user interface;
receive a request for selection of the at least one content item for the virtual collection;
establish accessibility to the at least one content item for the second user account; and
store the at least one content identifier for the virtual collection.

10. The system of claim 9, wherein accessibility to the content item for the second user account is determined by at least one of: (1) the content item is designated as shared with the second user account, (2) accessibility information for the content item indicates read and write privileges for the content item for the second user account, and (3) accessibility information for the virtual collection containing the content item indicates read and write privileges for the second user account.

11. The system of claim 9, the memory containing instructions that, when executed, further cause one or more processors to:
send a hash key for retrieval of the at least one visual representation from a cache of a client device, wherein the at least one visual representation comprises an image file.

12. The system of claim 9, the memory containing instructions that, when executed, further cause one or more processors to:
receive the request to create the virtual collection for a category of file; and
send a plurality of visual representations for content items identified for the category of file to a client device.

13. The system of claim 9, the memory containing instructions that, when executed, further cause one or more processors to:
receive a request to share the virtual collection with a third user account; and
provide a sharing link for the virtual collection to the third user account.

14. A nontransitory computer-readable medium containing instructions that, when executed by at least one processor of a computing device, cause the computing device to:
receive a request for display of a virtual collection of content items by a first user account with a content management system;
retrieve at least one content identifier stored for the virtual collection, wherein the at least one content identifier identifies a content item in data storage;
receive information on a new storage location within a file hierarchy for the content item stored for a second user account with a content management system;
store the new storage location with the content identifier within data storage;
receive information on a modification to the content item by the second user account that results in an updated content item;
retrieving accessibility information for the content item for the second user account; and
provide the updated content item for display with the virtual collection in accordance with the accessibility information.

15. The nontransitory computer-readable medium of claim 14, containing instructions that, when executed, further cause the computing device to:
receive a request to create a virtual collection for a first user account with a content management system;
retrieve at least one content identifier for at least one content item accessible to the first user account;
retrieve at least one visual representation for the at least one content item using the at least one content identifier; and
send the at least one visual representation to a device for rendering within a user interface.

16. The nontransitory computer-readable medium of claim 15, containing instructions that, when executed, further cause the computing device to:
receive a request for selection of the at least one content item for the virtual collection;
establish accessibility to the at least one content item for the second user account; and
store the at least one content identifier for the virtual collection.

17. The nontransitory computer-readable medium of claim 14, wherein accessibility to the content item for the second user account is determined by at least one of: (1) the content item is designated as shared with the second user account, (2) accessibility information for the content item indicates read and write privileges for the content item for the second user account, and (3) accessibility information for the virtual collection containing the content item indicates read and write privileges for the second user account.

18. The nontransitory computer-readable medium of claim 14, containing instructions that, when executed, further cause the computing device to:
send a hash key for retrieval of the at least one visual representation from a cache of a client device, wherein the at least one visual representation comprises an image file.

19. The nontransitory computer-readable medium of claim 14, containing instructions that, when executed, further cause the computing device to:
receive the request to create the virtual collection for a category of file; and
send a plurality of visual representations for content items identified for the category of file to a client device.

20. The nontransitory computer-readable medium of claim 14, containing instructions that, when executed, further cause the computing device to:
receive a request to share the virtual collection with a third user account; and
provide a sharing link for the virtual collection to the third user account.
